(19) United States
(12) Patent Application Publication
(10) Pub. No.: US 2005/0210324 A1
(43) Pub. Date: Sep. 22, 2005

(54) Data relay apparatus, data relay method, and computer product

(76) Inventors: Hideji Abe, Kawasaki (JP); Hiroyuki Sato, Kawasaki (JP); Hiroyuki Kaneko, Kawasaki (JP); Akihiro Asa, Kawasaki (JP)

Correspondence Address: KATTEN MUCHIN ROSENMAN LLP, 575 MADISON AVENUE, NEW YORK, NY, 10022-2585, US

(21) Appl. No.: 10/942,152

(22) Filed: Sep. 16, 2004

(30) Foreign Application Priority Data
Mar. 2, 2004 (JP) 2004-057849

(51) Int. Cl. G06F 11/00

(52) U.S. Cl. 714/18

(57) ABSTRACT

A data relay apparatus includes a storage unit that stores information generated based on contents of data, a determining unit that determines, based on the information, whether a communication path relating to the data is in a loop state when the data is received, and a limiting unit that limits relay of the data when the determining unit determines that the communication path is in the loop state.

### BACKGROUND OF THE INVENTION

1) Field of the Invention

The present invention relates to a data relay apparatus, a data relay method, and a data relay program, and more particularly, to a data relay apparatus, a data relay method, and a data relay program that can efficiently limit relay of a frame of a broadcast storm, which is caused by a loop path, without blocking normal broadcast communications.

2) Description of the Related Art

In recent years, a large-scale network such as wide-area Ethernet (registered trademark), which is constructed by connecting a large number of layer 2 switches are used. When an address cannot be resolved, the layer 2 switches relay the media access control (MAC) frame while broadcasting the MAC frame.

However, if the loop path is formed at a transmission path of the MAC frame when a network is newly constructed, or when network maintenance is carried out, the broadcast storm occurs, resulting in a network down.

The loop path is prevented by using a control technique called spanning tree. Spanning tree standards include IEEE 802.1D spanning tree protocol (STP), IEEE 802.1w rapid spanning tree protocol (RSTP), IEEE 802.1s multiple spanning tree protocol (MSTP).

However, the spanning tree control technique is essentially developed on the premise of use in a local area network (LAN), and has a problem that reliability of an application thereof is low in the wide-area Ethernet. For example, in this control technique, the loop path is prevented by exchanging control information among the layer 2 switches. However, when the network is large, this control takes time, and problems arise in an actual use.

Various methods to cope with the broadcast storm while overcoming the above problem have been proposed. One of the methods is disclosed in, for example, Japanese Patent Application Laid-Open No. H7-336373. In this method, a traffic control bridge counts the number of broadcast frames in a predetermined time, and limits the relay of the broadcast frames when a value counted exceeds a predetermined value.

Another method is disclosed in, for example, Japanese Patent Application Laid-Open No. H11-341039. In this method, a LAN switch that counts the number of frames that have a specific destination address, and discards the frames when a state in which the number of the frames per unit time exceeds a threshold value continues.

In another method, when the number of receiving of the broadcast frame is a threshold value or more, the received frame is discarded until the receiving is stopped. In a method disclosed in, for example, Japanese Patent Application Laid-Open No. 2003-124963, priorities are set for broadcast communications, and when the broadcast storm occurs, frames of the broadcast communications having a lower priority are discarded.

However, in the above conventional technologies, not only the broadcast frame caused by the loop path in the transmission path of the frame, but also the frame of the normal broadcast is discarded.

If the relay of the frame is limited based on a mere determination in which there are a large number of the frames, or a large number of frames are repetitively received, the normal broadcast communications can also be blocked.

Even if the priorities are set for the broadcast communications, and only frames of the broadcast communications of the lower priority are discarded, the frame to be discarded is not necessarily the frame caused by the loop path, which means that the method is inefficient.

### SUMMARY OF THE INVENTION

It is an object of the present invention to solve at least the above problems in the conventional technology.

A data relay apparatus according to one aspect of the present invention includes a storage unit that stores information generated based on contents of data; a determining unit that determines, based on the information, whether a communication path relating to the data is in a loop state when the data is received; and a limiting unit that limits relay of the data when the determining unit determines that the communication path is in the loop state.

A data relay method according to another aspect of the present invention includes storing information generated based on contents of data; determining, based on the information, whether a communication path relating to the data is in a loop state when the data is received; and limiting relay of the data when the communication path is determined to be in the loop state.

A computer-readable recording medium that stores a computer program that realizes a data relay method on a computer and that makes the computer execute storing information generated based on contents of data; determining, based on the information, whether a communication path relating to the data is in a loop state when the data is received; and limiting relay of the data when the communication path is determined to be in the loop state.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a functional block diagram of a layer 2 switch 10 according to an embodiment of the present embodiment;

FIG. 2 is an example of a frame structure of a MAC frame;

FIG. 3 is an example of an address learning table 40 that stores information of ports 11a to 11h and a source MAC address;

FIG. 4 is a flowchart of a MAC frame transmission process of the layer 2 switch 10 according to the present embodiment;

FIG. 5 is a flowchart of a frame filtering process shown in FIG. 4; and

FIG. 6 is a block diagram of a computer 100 that realizes functions of a data relay apparatus.

### DETAILED DESCRIPTION

Exemplary embodiments of a data relay apparatus, a data relay method, and a computer product according to the present invention will be explained in detail with reference to the accompanying drawings.

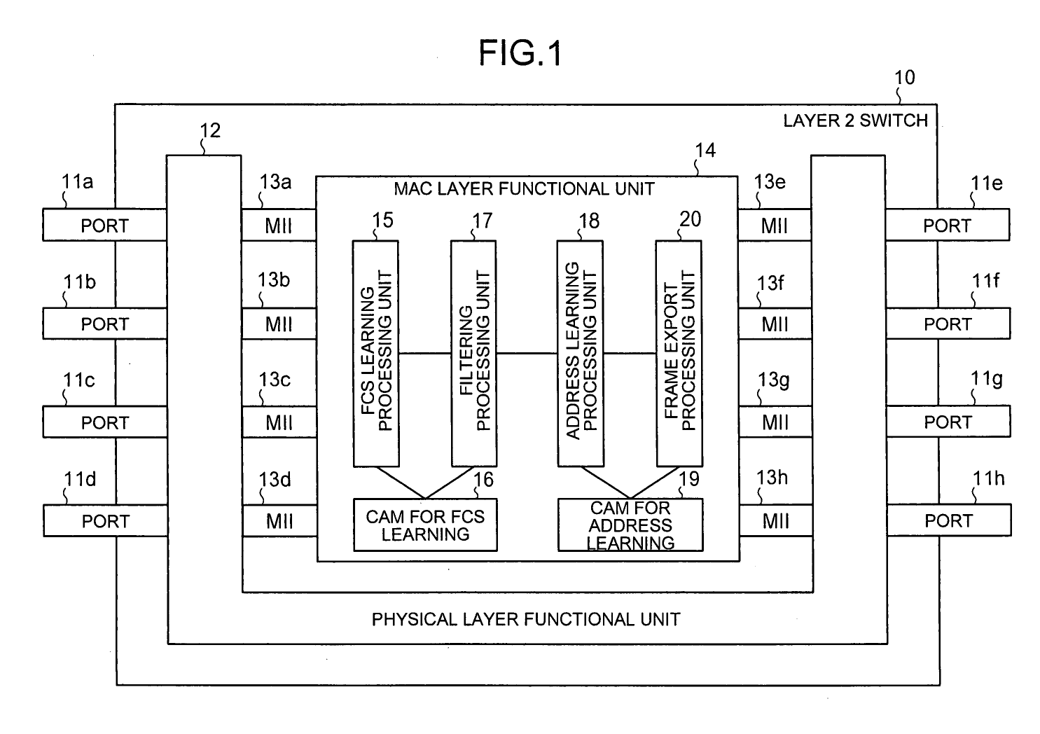

FIG. 1 is a functional block diagram of a layer 2 switch 10 according to an embodiment of the present invention. The layer 2 switch 10 analyzes a destination MAC address of a MAC frame received, and transfers the MAC frame from an appropriate port. When the destination MAC address cannot be resolved, the layer 2 switch broadcasts the MAC frame from all ports.

The layer 2 switch 10 not only transfers MAC frames, but also stores, in a memory, a frame check sequence (FCS) that is included in the MAC frame as information to identify each of the MAC frame. When a MAC frame is newly received, the layer 2 switch 10 checks whether a same MAC frame as the MAC frame newly received has been received before by comparing the FCS stored in the memory and an FCS of the MAC frame newly received.

Thus, the layer 2 switch can detect a MAC frame that is transmitted via a loop path of a network. Therefore, the layer 2 switch can efficiently limit a relay of a MAC frame of a broadcast storm caused by the loop path, without blocking normal broadcast communications.

As shown in FIG. 1, the layer 2 switch 10 includes ports 11a to 11h, a physical layer functional unit 12, media independent interfaces (MIIs) 13a to 13h, and a MAC layer functional unit 14.

The ports 11a to 11h connect the layer 2 switch 10 to other devices. The physical layer functional unit 12 transmits and receives the MAC frame via the ports 11a to 11h. The MIIs 13a to 13h are interfaces that transmit and receive data between the physical layer functional unit 12 and the MAC layer functional unit 14.

The MAC layer functional unit 14 analyzes the destination MAC address of the MAC frame and controls to transfer the MAC frame from the appropriate port. The MAC layer functional unit 14 includes an FCS learning processing unit 15, a content addressable memory (CAM) 16 for FCS learning, a filtering processing unit 17, an address learning processing unit 18, a CAM 19 for address learning, and a frame export processing unit 20.

Based on a FCS value included in the MAC frame, the FCS learning processing unit 15 determines whether a communication path of the MAC frame is in a loop state. Specifically, the FCS learning processing unit 15 acquires the FCS value, and checks whether a same FCS value as the FCS value acquired is stored in the CAM 16.

If the same FCS value is stored in the CAM 16, the FCS learning processing unit 15 increases a value of a counter that is provided corresponding to the FCS value by 1, and compares the value of the counter with a threshold value that is set in advance.

When the value of the counter is greater than the threshold value, the FCS learning processing unit 15 determines that the communication path of the MAC frame is in the loop state. The value of the counter is initialized when a predetermined time (an aging time) has passed.

If the same FCS value is not stored in the CAM 16, the FCS learning processing unit 15 stores that FCS value in the CAM 16.

The aging time and the threshold value may not be fixed, and the FCS learning processing unit 15 can change settings for the aging time and the threshold value when the FCS learning processing unit 15 accepts requests for changes.

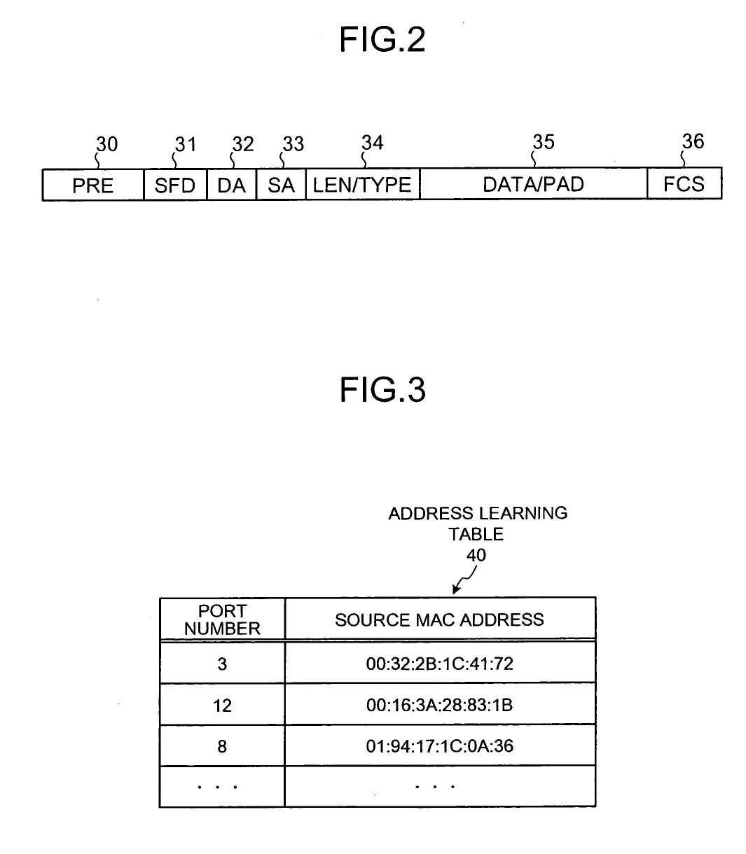

FIG. 2 is an example of a frame structure of the MAC frame. The MAC frame is formed of a preamble (PRE) 30, a start frame delimiter (SFD) 31, a destination address (DA) 32, a source address (SA) 33, a length (LEN)/TYPE 34, a DATA/PAD 35, and an FCS 36.

The PRE 30 is a signal that is used for clock synchronization. The SFD 31 is a field that indicates a beginning of the MAC frame. The DA 32 and the SA 33 are fields that indicate the destination MAC address and the source MAC address respectively.

The LEN/TYPE 34 is a field that indicates length of a data field of the DATA/PAD 35 and a frame type. The DATA/PAD 35 is the field of the data to be transmitted. When the length of the data is less than predetermined length, dummy data called PAD is attached to the data.

The FCS 36 is a field that is attached to the MAC frame for detecting a transmission error of the MAC frame. A value that is obtained by applying a predetermined formula to the DA 32, the SA 33, the LEN/TYPE 34, and the DATA/PAD 35, is attached at the FCS 36. A device that receives the MAC frame, to which the FCS 36 is attached, calculates an FCS using the same formula, and when the FCS calculated is not identical to the value attached, determines that the transmission error has occurred.

Referring back to FIG. 1, the CAM 16 is a storage unit that stores the FCS value detected by the FCS learning processing unit 15.

When it is determined that the communication path of the MAC frame is in the loop state, the filtering processing unit 17 discards the MAC frame.

Based on the source MAC address of the MAC frame and information of the ports 11a to 11h at which the MAC frame is received, the address learning processing unit 18 learns which port from among the ports 11a to 11h should export the MAC frame having a predetermined destination MAC address.

Specifically, the address learning processing unit 18 stores the source MAC address and the information of the ports 11a to 11h in the CAM 19 by associating the source MAC address and the information of the ports 11a to 11h. When the destination MAC address is same as the source MAC address stored, the MAC frame should be exported from the port corresponding to the source MAC address.

The address learning processing unit 18 deletes the information of the ports 11a to 11h from which the MAC frame is exported, and that correspond to the destination MAC address of the MAC frame that is discarded by the filtering processing unit 17 from the CAM 19.

The CAM 19 is a storage unit that stores the source MAC addresses of the MAC frame received and the information of the ports 11a to 11h at which the MAC frame is received by associating the source MAC addresses and information of the ports 11a to 11h. FIG. 3 is an example of an address learning table 40 that stores the information of the ports 11a to 11h and the source MAC address.

As shown in FIG. 3, the address learning table 40 stores a port number and the source MAC address. The port number is information for identifying the ports 11a to 11h that receives the MAC frames. The source MAC address is information that indicates the source MAC address of the MAC frame received at each of the ports 11a to 11h.

When one of the MAC frame is discarded by the filtering processing unit 17, the information of the port number and the source MAC address that correspond to the destination MAC address of the MAC frame discarded is deleted from the address learning table 40.

Referring back to FIG. 1, the frame export processing unit 20 refers to the CAM 19 to determine which one of the ports 11a to 11h should the MAC frame be exported from, and exports the MAC frame.

Specifically, when the MAC frame is to be exported, the frame export processing unit 20 retrieves the source MAC address, which is the same as the destination MAC address of that MAC frame, from the CAM 19. The frame export processing unit 20 acquires the information of the port number corresponding to the source MAC address from the CAM 19, and exports the MAC frame from a port of the port number among the ports 11a to 11h.

When the frame export processing unit 20 cannot retrieve the source MAC address, which is the same address as the destination MAC address, the frame export processing unit 20 broadcasts the MAC frame from all of the ports 11a to 11h.

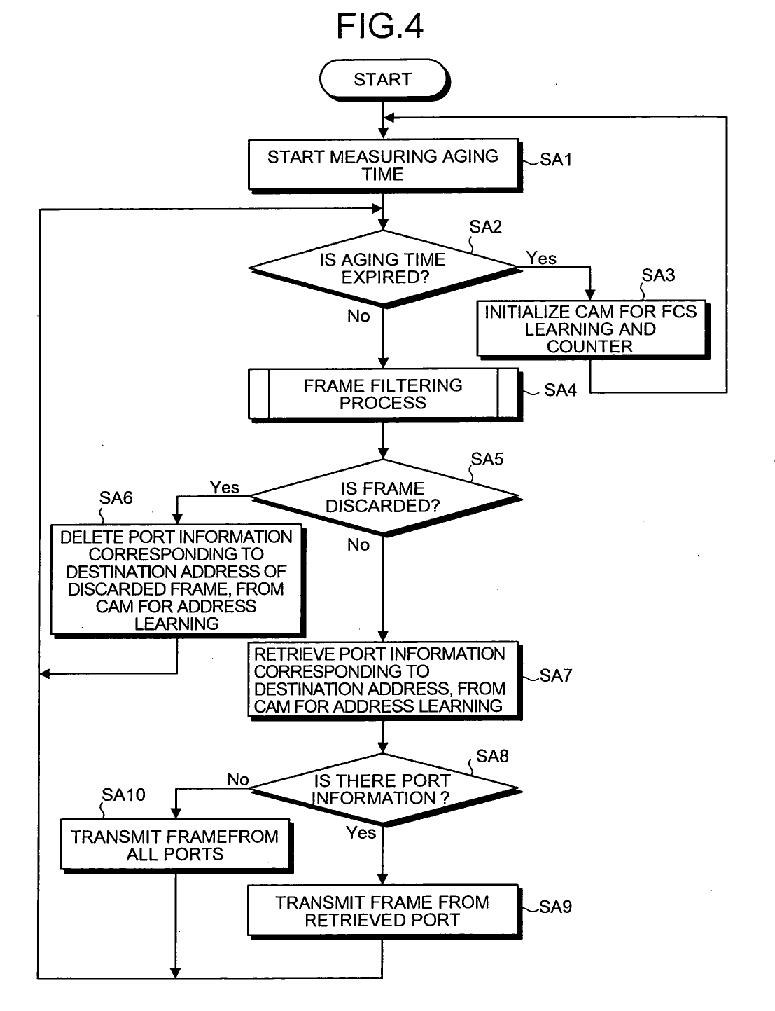

FIG. 4 is a flowchart of a MAC frame transmission process of the layer 2 switch 10 according to the present embodiment. The FCS learning processing unit 15 of the layer 2 switch 10 first starts measuring time of learning the FCS (the aging time) (step SA1). The FCS learning processing unit 15 then checks whether the aging time has expired (step SA2). If the aging time has expired (step SA2, Yes), the FCS learning processing unit 15 initializes the information of the FCS stored in the CAM 16, and the counter set for each of the FCS.

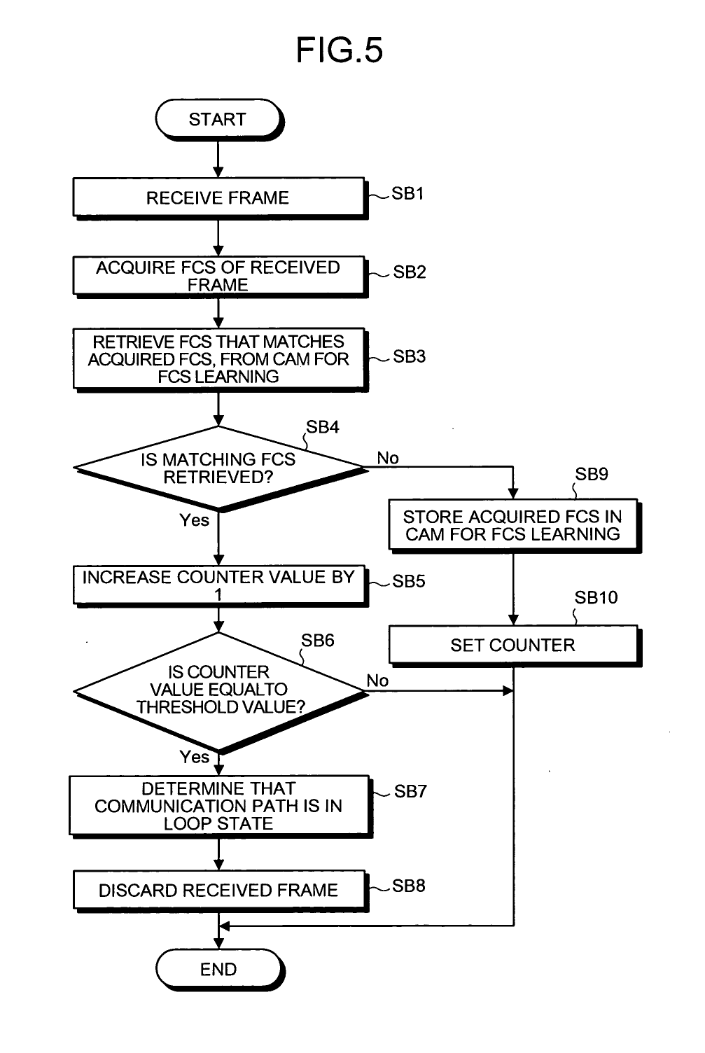

Based on the FCS value included in the received MAC frame, the FCS learning processing unit 15 and the filtering processing unit 17 then determine whether the communication path of the MAC frame is in the loop state. If it is determined to be in the loop state, a MAC frame filtering processing is carried out to discard that MAC frame (step SA4). The MAC frame filtering processing is explained in further detail with reference to FIG. 5.

Thereafter, the address learning processing unit 18 checks whether the MAC frame has been discarded by the filtering processing unit 17 (step SA5). If the MAC frame has been discarded (step SA5, Yes), the address learning processing unit 18 deletes the information of the port 11a to 11h corresponding to the destination MAC address of the MAC frame discarded (step SA6).

If the MAC frame has not been discarded (step SA5, No), the frame export processing unit 20 retrieves the information of the port corresponding to the destination MAC address from the CAM 19 (step SA7), and checks whether the information of the port 11a to 111h is stored in the CAM 19 (step SA8).

When there is information of a port corresponding to the destination MAC address among the ports 11a to 11h (step SA8, Yes), the frame export processing unit 20 transmits the MAC frame from the port (step SA9). A routine proceeds to step SA2, and the process thereafter are repeated.

If there is no information of the port corresponding to the destination MAC address among to the ports 11a to 11h (step SA8, No), the frame export processing unit 20 broadcasts the MAC frame from all of the ports 11a to 11h (step SA10). The routine proceeds to step SA2, and the processes from thereon are continued.

FIG. 5 is a flowchart of the frame filtering processing shown in FIG. 4. As shown in FIG. 5, the FCS learning processing unit 15 of the layer 2 switch 10 receives the MAC frame (step SB1), and acquires the FCS value of the received MAC frame (step SB2). The FCS learning processing unit 15 then retrieves, from the CAM 16, the FCS value that matches the FCS value acquired (step SB3).

The FCS learning processing unit 15 checks whether the FCS value that matches the FCS value acquired has been retrieved from the CAM 16 (step SB4). If the FCS value that matches the FCS value acquired has been retrieved (step SB4, Yes), the FCS learning processing unit 15 increases by 11 the value of the counter corresponding to that FCS value (step SB5).

Then, the FCS learning processing unit 15 checks whether the value of the counter is equal to a threshold value (step SB6). If the value is equal to the threshold value (step SB6, Yes), the FCS learning processing unit 15 determines that the communication path of the MAC frame is in the loop state (step SB7).

The filtering processing unit 17 discards the MAC frame of which the communication path is determined to be in the loop state (step SB8), and ends this frame filtering processing. If the value of the counter is less than the threshold value (step SB6, No), the filtering processing unit 17 ends the frame filtering process.

If the FCS value that matches the FCS value acquired has not been retrieved from the CAM 16 (step SB4, No) at step SB4, the FCS learning processing unit 15 stores the FCS value acquired in the CAM 16 (step SB9). In addition, the FCS learning processing unit 15 sets a counter in correspondence with the FCS value stored (step SB10), and ends the frame filtering process.

As described above, according to the present embodiment, the FCS learning processing unit 15 stores, in the CAM 16, the FCS that is generated based on contents of the MAC frame. When the FCS learning processing unit 15 receives the MAC frame, the FCS learning processing unit 15 determines, based on the information of the FCS stored, whether the communication path relating to the MAC frame is in the loop state. If the communication path is in the loop state, the filtering processing unit 17 limits the relay of the MAC frame. Therefore, the relay of a MAC frame of the broadcast storm caused by the loop path can be efficiently limited without blocking the normal broadcast communications.

Furthermore, according to the present embodiment, the FCS learning processing unit 15 counts the number of receiving the MAC frame corresponding to each of the FCS within the predetermined aging time, and determines whether the communication path relating to that MAC frame is in the loop state by comparing the number with the threshold value. Therefore, a reference value for determining whether the communication path is in the loop state can be adjusted by changing the threshold value, and the relay of the MAC frame of the broadcast storm caused by the loop path can be efficiently limited.

Moreover, according to the present embodiment, the FCS to check the transmission error is used as the information generated based on the contents of the MAC frame. Thus, by using the FCS, the MAC frame of the broadcast storm is easily detected, and the relay of that MAC frame can be efficiently limited.

The FCS learning processing unit 15 accepts changes in the aging time and the threshold value in the present embodiment. Therefore, by changing the aging time and the threshold value appropriately, the reference value for determining whether the communication path is in the loop state can be changed. As a result, the relay of the MAC frame of the broadcast storm can be efficiently limited.

Furthermore, according to the present embodiment, when the relay of the MAC frame is limited, the filtering processing unit 17 deletes the information of the port corresponding to the destination MAC address included in the MAC frame, from the address learning table 40, which stores the destination information of the MAC frame and information of the ports from which the MAC frame is exported by associating the destination information and the information of the ports. Thus, while efficiently utilizing a storage region that stores the information, the relay of the MAC frame of the broadcast storm can be efficiently limited.

Exemplary embodiments of the present invention have been explained above with reference to the accompanying drawings, however, specific configurations are not limited to examples in the present embodiment, and the aspects of the invention include various design changes within a scope not departing from the spirit of the claims.

For example, functions of the data relay apparatus may be realized by executing a program for realizing the functions on a computer. The program may be stored in a computer readable recording medium.

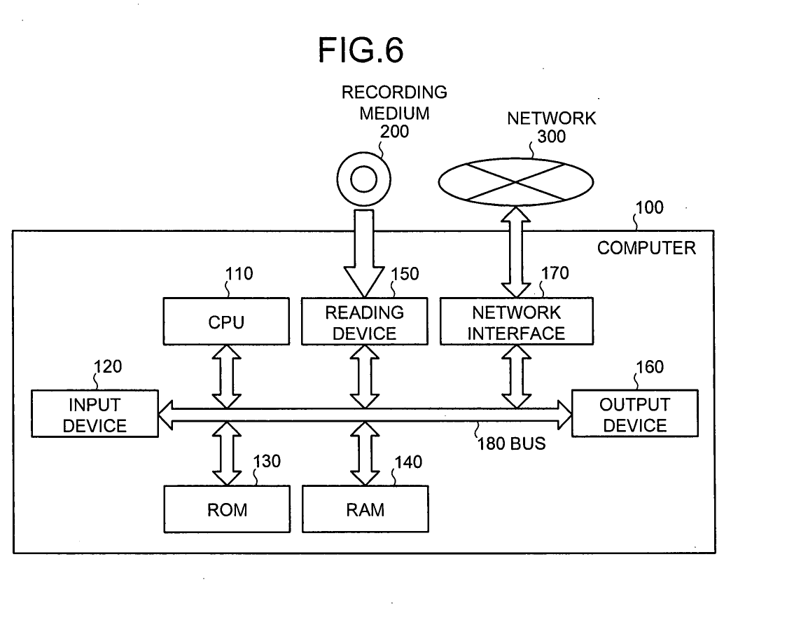

FIG. 6 is a block diagram of a computer 100 that realizes functions of the data relay apparatus. The computer 100 is includes a central processing unit (CPU) 110 that executes the program, an input device 120 that inputs data, a read only memory (ROM) 130 that stores various types of data, a random access memory (RAM) 140 that stores arithmetic parameters, a reading device 150 that reads the program from a recording medium 200 in which this program is recorded, an output device 160 such as a display, and a network interface 170 that transmits and receives data to and from other computers via a network 300, being connected by a bus 180.

After the CPU 110 has read the program via the reading device 150, the CPU 110 realizes the functions described above by executing the program. The recording medium 200 is, for example, an optical disk, a flexible disk, a CD-ROM, and a hard disk. The program may also be introduced into the computer 100 via the network 300.

In the present embodiment, the layer 2 switch is used as an example of the data relay apparatus. However, the present invention is not limited to the same, and may be applied to other network devices that carry out the data relay process. The present invention may also be applied to a network device that has a virtual LAN (VLAN) function.

Although in the present embodiment, the FCS is used as the information generated based on the contents of the data, the present invention is not limited to the same. Other information that is generated based on the contents of the data may also be used.

Furthermore, all or a part of the processes explained as the processes performed automatically may be performed manually, or all or a part of the processes explained as processes performed manually may be performed automatically by a known method. The information that includes the procedure of the process and the control, specific names, and various kinds of data and parameters that are included in the data or shown in the drawings may be arbitrarily changed unless otherwise specified.

Each of the components illustrated are expressed in a functional concept, and it is not necessary to configure physically same as configuration illustrated. Therefore, a specific mode of dispersion and integration of the components in the apparatus is not limited to the mode illustrated, and all or a part of the components may be functionally or physically dispersed or integrated in an arbitrary unit, according to various kinds of load and use.

Moreover, all or an optional part of the functions of the apparatus can be realized by the CPU or a computer program that can be analyzed and executed by the CPU, or can be realized as hardware using a wired logic.

According to the present invention, generated information, a relay of a frame of a broadcast storm caused by a loop path can be efficiently limited without blocking normal broadcast communications.

Furthermore, according to the present invention, the frame of the broadcast storm caused by the loop path can be easily detected, and the relay of the frame can be efficiently limited.

Moreover, according to the present invention, a reference value for determining whether a communication path is in the loop state can be adjusted by changing a threshold value, and the relay of the frame of the broadcast storm caused by the loop path can be efficiently limited.

Furthermore, according to the present invention, the reference value for determining whether the communication path is in the loop state can be easily changed by appropriately changing a measurement time or the threshold value, and the relay of the frame of the broadcast storm caused by the loop path can be efficiently limited.

Moreover, according to the present invention, while a storage region that stores information can be efficiently utilized, the relay of the frame of the broadcast storm caused by the loop path can be efficiently limited.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A data relay apparatus comprising:
a storage unit that stores information generated based on contents of data;
a determining unit that determines, based on the information, whether a communication path relating to the data is in a loop state when the data is received; and
a limiting unit that limits relay of the data when the determining unit determines that the communication path is in the loop state.

2. The data relay apparatus according to claim 1, wherein
the determining unit includes a threshold value, and
the determining unit counts number of receiving the data corresponding to the information within a predetermined time, and determines whether the communication path is in the loop state by comparing the number counted with the threshold value.

3. The data relay apparatus according to claim 1, wherein the information is a check code to check a transmission error of the data.

4. The data relay apparatus according to claim 2, wherein the determining unit accepts a change in at least one of the predetermined time and the threshold value.

5. The data relay apparatus according to claim 1, further comprising an information deleting unit that deletes, when the relay of the data is limited by the relay limiting unit, information on a first port corresponding to destination information included in the data from information stored by associating the destination information of the data with information on a second port from which the data is exported.

6. A data relay method comprising:
storing information generated based on contents of data;
determining, based on the information, whether a communication path relating to the data is in a loop state when the data is received; and
limiting relay of the data when the communication path is determined to be in the loop state.

7. A computer-readable recording medium that stores a computer program for realizing a data relay method on a computer, the computer program making the computer execute:
storing information generated based on contents of data;
determining, based on the information, whether a communication path relating to the data is in a loop state when the data is received; and
limiting relay of the data when the communication path is determined to be in the loop state.
